(19) United States
(12) Patent Application Publication
(10) Pub. No.: US 2019/0126967 A1
(43) Pub. Date: May 2, 2019

(54) FURNITURE DOLLY WITH IN-LINE WHEELS

(71) Applicant: John Sanders, Poway, CA (US)

(72) Inventor: John Sanders, Poway, CA (US)

(21) Appl. No.: 16/162,067

(22) Filed: Oct. 16, 2018

Related U.S. Application Data
(60) Provisional application No. 62/577,545, filed on Oct. 26, 2017.

(51) Int. Cl. B62B 5/02; B62B 3/00

(52) U.S. Cl. CPC B62B 5/02; B62B 2301/08; B62B 3/008

(57) ABSTRACT

A flat furniture dolly for moving furniture, building and garden materials, and other objects too heavy to be readily moved by human effort alone, which includes a platform for supporting the load, two rows of fixed wheels to allow free movement across flat ground and to allow the traversal of small obstacles such as small steps and broken concrete, and a rope attached to one end of the platform to provide additional control when crossing irregular surfaces.

This application claims priority from provisional application No. 62/577, 545; filed Oct. 26, 2017, the entire contents of which are herewith incorporated by reference.

### BACKGROUND

In the handling of industrial, construction, horticultural and domestic objects, items too large for a person to easily carry have to be moved through doorways, over thresholds, steps and irregular surfaces, as well as level ground. It is often necessary to use dollies or hand carts to move these items. In cases where the floor or paving are smooth and continuous, the dolly and the load may be moved by one person. When obstacles are encountered, more people are required, and/or planks, sheets of plywood or steel plates are required to bridge the obstacle.

Wheeled dollies having casters and/or fixed wheels mounted at the corners to a dolly are well-known for transport of miscellaneous coherent loads.

It is accordingly an object of the dolly to provide a compact furniture dolly, which is small, lightweight and maneuverable both on flat surfaces and over small obstacles.

### SUMMARY

The dolly describes a dolly that may be moved by one person, and minor obstacles negotiated single handedly.

In accordance with the dolly, there is provided a furniture dolly which includes a horizontal platform, two rows of in-line wheels, inset from both front and rear of the platform and inset from the edges, and a length of cord or rope attached to the front of the platform. The platform may be a continuous sheet of strong rigid material, or an open frame of strong rigid material. Two rows of inline wheels are mounted symmetrically under the platform, inset by about 10% of the platform's width from the respective edges. The rows of wheels are mounted symmetrically in the center 60% of the platform's length. The overhang on each edge of the platform allows the dolly to be tilted laterally or in-line of motion for maneuvering by applying pressure to the load. The wheels are fixed in line so the dolly freely rolls backwards and forwards but no provision for taking a curved course is provided in the wheels' mounting.

Any number of wheels may be used within the constraints of wheel size and practical length of the dolly. A sufficient number of wheels are provided to prevent the dolly grounding when maneuvered over a raised obstacle such as a door threshold. The dolly may employ the type of wheels used by in-line skates also known as roller blades. These provide free movement from good quality bearings and are resilient to shocks and transverse stresses. The dolly does not preclude other types of wheels.

A rope or cord is attached to the front edge of the platform, which is used to apply forward force directly to the dolly when resistance to the wheels is encountered, so the load is not displaced, as would be the case if the force was applied to the load alone.

The dolly allows one person to move heavy objects, including furniture, building materials, industrial parts and materials, and landscape and garden objects and materials. On a level surface, the dolly tends to travel in a straight line, but may be steered through a large radius curve by light lateral pressure from the operator. The dolly also allows negotiation of small radius bends by tilting the load so only the front or rear wheels are in contact with the ground and the dolly and load may be turned on the spot by the operator. Small steps and other raised obstacles are negotiated by tilting the platform so the leading wheels are raised sufficiently to alight on the top of the obstacle, and then reverse tilting raises the trailing wheels so they roll onto the top of the obstacle.

It is an object of the present dolly to provide an improved furniture moving dolly adapted to negotiate bumps or other obstructions.

It is another object of the present dolly to provide an improved furniture moving dolly adaptable for use by one man.

It is a further object of the present dolly to provide an improved furniture moving dolly which can be employed by one individual without injury to himself or damage to the furniture.

It is a further object of the present dolly to provide an improved furniture moving dolly which moves with reduced friction over unimpeded surfaces.

It is a further object of the present dolly to provide an improved furniture moving dolly which on smooth surfaces tends to follow a straight line.

The subject matter which I regard as my dolly is particularly pointed out and distinctly claimed in the concluding portion of this specification. The dolly, however, both as to organization and method of operation, together with further advantages and objects thereof, may best be understood by reference to the following description taken in connection with the accompanying drawings wherein like reference characters refer to like elements.

### BRIEF DESCRIPTION OF THE DRAWINGS

FIG. 1 is a perspective view of a furniture dolly according to the present dolly;

FIG. 2 is a side view of a furniture dolly according to the present dolly

FIG. 2a is a side view of a furniture dolly according to the present dolly showing a variant wheel arrangement.

FIG. 3 is end view of a furniture dolly according to the present dolly illustrating the end where the rope is attached.

FIG. 4 is a bottom view of the furniture dolly according to the present dolly.

FIG. 5 A-D is a series of side views of the furniture dolly according to the present dolly illustrating the method of traversal of an obstacle while carrying a load.

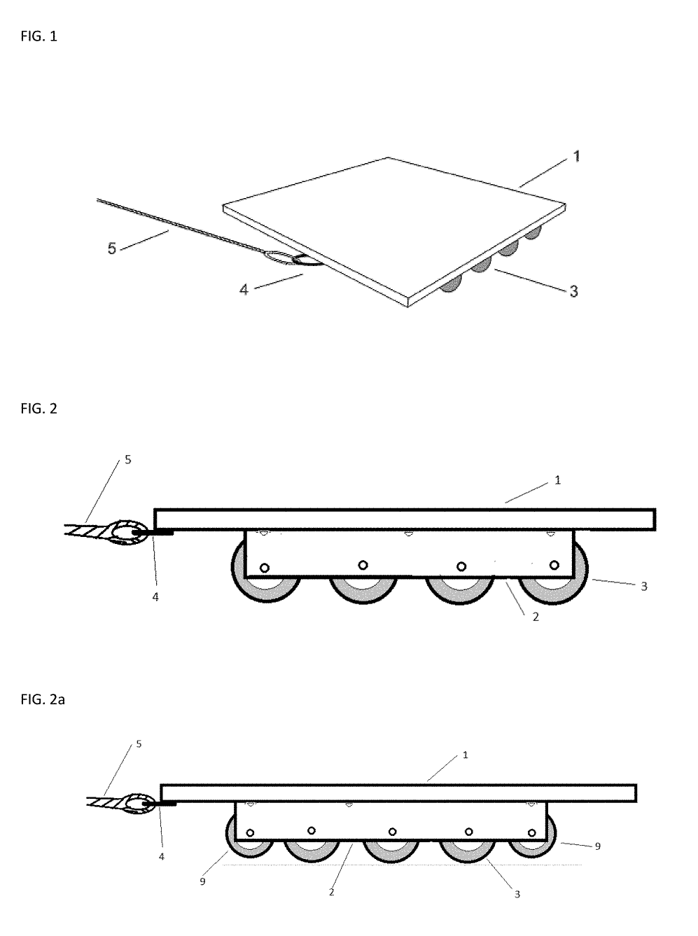

### DETAILED DESCRIPTION

Referring to the drawings, a furniture dolly according to the present dolly comprises a horizontal platform 1 mounted on two rows of in-line wheel assemblies comprising mounting brackets 2, wheels 3, and axles 6. The in-line wheel assemblies 2,3 are inset from both front and rear of the platform and inset from the edges of the horizontal platform 1. A fixing eye 4 is provided in the center of the front edge of the platform 1, and a length of attaching cord, e.g., rope 5 attached to the platform 1 by use of this eye 4. A spring clip of the type used on a dog's leash can be used to attach or detach the rope from the eye at the front of the platform.

The platform 1 is a rectangle of strong rigid material. Its upper surface is essentially flat, but may be textured, or provided with ridges, knobs or other devices to reduce the likelihood of the load slipping during movement. The underside of the platform 1 may be flat, ribbed or contoured to enhance physical strength and to aid assembly in manufacture. The platform 1 may be constructed from a continuous sheet of strong rigid material, such as plywood, steel, metal alloy or composite plastic material, or an open frame of wooden boards or similar material or may use any combination of these materials.

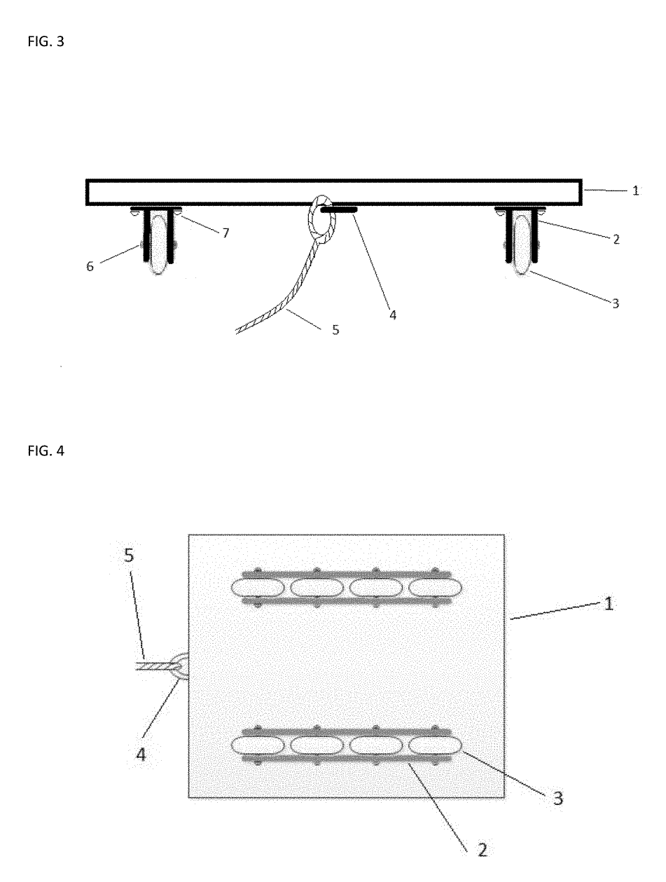

The platform 1 has two inline wheel assemblies attached to its underside as shown in FIGS. 3 and 4, using wood screws, nut and bolts or other fasteners 7 as compatible with the construction of the platform. The platform 1 projects symmetrically beyond the wheel assemblies by approximately 20% of its length at both front and back. The wheel assemblies are inset from the edges of the platform 1 so that the centers of the wheels 3 are inset from their respective sides of the platform 1 by approximately 10% of the platform's width. The platform 1 may incorporate reinforcing components to distribute the load to the wheel assemblies, such as steel inserts in the case of a molded composite platform.

An eye 4 is provided in the front center of the platform 1. The eye may comprise a molded, drilled or otherwise formed hole through the platform, or may be a separate component attached with fasteners compatible with the composition of the platform. The platform may be contoured to accommodate the eye 4 for both the integral and attached variations. The platform 1 may include local reinforcement to spread the stress applied by the eye 4.

Each wheel assembly comprises a robust mounting bracket or pair of brackets 2, to which a number of wheels 3 are attached to one face via their axles 6. The brackets attach to the underside of the platform by another face at right angles to the face attaching the wheels. The bracket 2 takes the form of a metal angle or channel, and may be cut and drilled from a standard rolled or extruded metal stock or may be custom molded, formed or stamped for the purpose. The brackets 2 may employ ribbing or contouring to enhance strength. The brackets 2 are fixed to the platform so there is no movement between them and the platform 1, and in one embodiment of this dolly, the brackets could be formed from part of the platform molding.

The wheels 3 are attached to the bracket(s)2 to form an in-line configuration. Each wheel 3 can rotate freely in either direction, but its orientation is fixed parallel with the long axis of the bracket 2. When the dolly is placed on a flat surface, all wheels 3 are in contact with the surface in the first embodiment of this dolly. In an alternative embodiment of this dolly, the leading and trailing wheels 9 of each assembly may be slightly raised from the ground to aid tipping the dolly to negotiate obstacles. Three to six wheels 3 are attached in-line to each wheel assembly, depending on projected load carrying, size of wheels and environment the dolly is designed for use in. More than one line of wheels in each wheel assembly may also be used for transporting heavier loads or spreading the load on weaker surfaces.

For optimum performance, the dolly will employ the type of wheels used by in-line skates also known as roller blades. These provide free movement from good quality bearings and are resilient to shocks and transverse stresses. Two bearings are used per wheel. The bearings slip into openings molded into each side of the wheel hub, and a flange molded into the wheel hub holds the bearings a distance apart from one another. Additionally there can be an axle spacer. In one embodiment, the wheels can be made of polyurethane.

Other types of wheels may be used, as long as they provide low resistance bearings and ability to individually support the whole design loading of the dolly on one pair of wheel. Wheel diameters are in the range 2 inches to 4 inches.

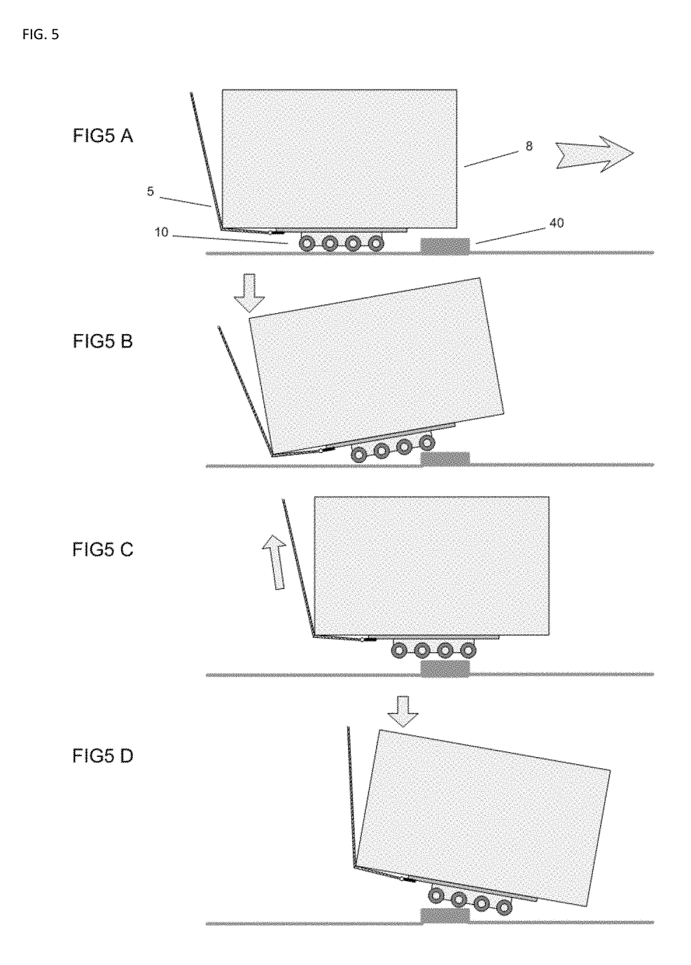

The rope or cord attached to the eye is made of a conventional fiber with qualities of comfort for handling and bearing a load in excess of the projected load carried by the dolly. Its length is determined by the envisaged load for the dolly, so that it would reach from the dolly under the largest load to the hand of the operator as illustrated in FIG. 5.

For carriage of a bulky load over a smooth level surface the dolly is placed beneath the center of gravity of the load, and the load moved in a straight line by light pressure on the load by the operator. In this environment, the dolly is operated with the eye and rope on the trailing edge so to provide an additional hand hold if the operator wishes to slow or stop the dolly, as shown in FIG. 5A.

Steering left or right over large radius curves is achieved by gentle lateral pressure on the load while maintain forward motion. If an abrupt change of direction is required, the operator stops the dolly and tilts the load backwards, thus causing the dolly to tilt with the load and raise all but its rear wheels from the surface as shown in FIG. 5B. This allows the load and the dolly to be rotated on the spot. With lighter loads, the same tilting technique can be applied on the move providing sharper turns while in motion.

For carriage of a small heavy load, the dolly is reversed so the eye and rope are at the leading edge, and the dolly is pulled by the operator using the rope in straight lines. Large radius curves are negotiated by applying the tension to the rope with a bias to the direction of turn. When the weight of the load allows, sharp turns are made by lifting the front of the dolly with upward tension on the rope. Applying sharp turns to heavier loads requires the operator to move to the back of the dolly and apply downward pressure with a foot to the rear of the dolly while pulling on the rope to lift the front and turning the dolly.

FIG. 5 shows the sequence of events when an obstacle is encountered such as a threshold or a low rock while transporting a large load 8 across a surface. FIG. 5 A shows the dolly 10 traveling over a level surface in the direction indicated by the angled arrow. The rope 5 is held taut by a walking operator (not shown) who is pushing the load and dolly forward. FIG. 5 B shows the dolly 10 encountering an obstacle 40. The rear overhang of the platform allows the operator to tilt the dolly by applying downward pressure on the load if it is large or directly to the rear of the platform with a foot. This will raise the front wheels while continuing to move forward so to place the front wheels on the top of the obstacle. As illustrated in FIG. 5 C, the operator then applies upward pressure to the rear of the load or pulls upward on the rope if the dolly is orientated with the rope to the rear, to raise the back wheels so the dolly is once more horizontal and can move forward across the obstacle. As the dolly moves forward, the front wheels take the load as the obstacle is crossed. FIG. 5 D shows when the dolly reaches the point where the weight load is born by the rear wheels and balance is no longer maintained, the operator applies downward pressure again to the rear of the load to control the descent of the front wheels to the original surface.

A hollow in the surface would be negotiated in the opposite sequence.

When a small load is being transported, the dolly will generally be oriented to have the rope at the front, when the operator will use the rope to raise and lower the front of the dolly.

In cases when very rough ground is traversed the dolly and load can be tilted sideways to insert wood or other packing material under one set of wheels should the dolly become jammed between obstacles or bogged down in a soft surface.

The dolly is equally operable with two operators. The orientation of the dolly with respect to the rope would remain the same as for the single operator case.

Although only a few embodiments have been disclosed in detail above, other embodiments are possible and the inventors intend these to be encompassed within this specification. The specification describes certain technological solutions to solve the technical problems that are described expressly and inherently in this application. This disclosure describes embodiments, and the claims are intended to cover any modification or alternative or generalization of these embodiments which might be predictable to a person having ordinary skill in the art. For example, the in-line rows of wheels are embodied as a plurality of rows in each mounting assembly so to distribute the load over a greater surface can be used.

Where a specific numerical value is mentioned herein, it should be considered that the value may be increased or decreased by 20%, while still staying within the teachings of the present application, unless some different range is specifically mentioned. Where a specified logical sense is used, the opposite logical sense is also intended to be encompassed.

The previous description of the disclosed exemplary embodiments is provided to enable any person skilled in the art to make or use the present dolly. Various modifications to these exemplary embodiments will be readily apparent to those skilled in the art, and the generic principles defined herein may be applied to other embodiments without departing from the spirit or scope of the dolly. Thus, the present dolly is not intended to be limited to the embodiments shown herein but is to be accorded the widest scope consistent with the principles and novel features disclosed herein.

What is claimed is:

1. A load moving dolly comprising:
a platform defining a top surface adapted to hold a load;
a first wheel assembly and a second wheel assembly, each attached to an underside of the platform and spaced from one another;
each wheel assembly comprising a mounting bracket and a plurality of wheels arranged as an in-line row of wheels, secured to one another in supporting relation to said platform,
each wheel mounted on a fixed axis maintaining the wheel parallel to sides of the platform, and perpendicular to the top surface of the platform,
said first wheel assembly and said second wheel assembly attached to a location on the underside of the platform that is inset equally from edges of the platform,
a first of said wheels in each wheel assembly, herein a front wheel in the wheel assembly, inset from a front of the platform, and both said front wheels inset from the front of the platform by a same distance,
a last of said wheels in each wheel assembly, herein a rear wheel in the wheel assembly, inset from a rear of the platform and both said rear wheels inset from a back of the platform by a same distance as each other and a same distance as said front wheels.

2. The dolly of claim 1 further comprising an eye at a center of a front edge of said platform used for attaching an attaching cord.

3. The dolly of claim 2 further comprising an attaching cord that attaches to said eye.

4. The dolly of claim 3 wherein the cord is a rope that is made of a fiber that makes the rope comfortable to be held by hand.

5. A furniture dolly comprising:
a rectangular platform made from a hardened flat material wherein the hardened flat material is one of plywood, wooden planking, formed steel or alloy, or molded composite material or a combination of any of any of these, and has an upper surface, and
first and second assemblies comprising mounting brackets and a plurality of roller-blade wheels with bearings, mounted as in-line rows, secured in supporting relation to said platform with a plurality of fasteners, where the fasteners are wood screws, bolts, or rivets, or using an extension of the platform molding as support brackets, adapting the same to traverse a substantially horizontal surface,
said wheels mounted in rows numbering three to six in each row with the same number in both rows, each wheel mounted on a fixed axis maintaining the wheel parallel to
sides of the platform, and perpendicular to a top surface of the platform;
where the wheels spaced to lie on a line inset from each edge of said platform by approximately 10% of a width of said platform, the center of a first wheel in each assembly is inset by approximately 25% of a length of said platform from a vertical drawn from a front edge of said platform, and both front wheels inset from the front of the platform by the same distance, the center of the last wheel in each assembly is inset by approximately 25% of the length of said platform from a vertical drawn from a rear edge of the platform and both rear wheels spaced from a back of the platform by the same distance.

6. The dolly of claim 5 further comprising an eye at the center of a leading edge of said platform, where the eye has inner surfaces used for attaching a rope.

7. The dolly of claim 6 further comprising a rope of that attaches to said eye, said rope being of sufficient length to be held by a standing operator handling a large load mounted on the dolly.

8. The furniture dolly as in claim 5,
where said platform is rectangular with its shorter sides not being less than 66% of a length of its long sides,
and upper lower surfaces of the platform are substantially flat.

9. The dolly of claim 5 further comprising one of texturing, knobs or ridges on an upper surface of the platform, to reduce slippage of a load on the upper surface.

10. The dolly of claim 5 further comprising ribs or contouring on a lower surface of the platform to increase load bearing strength and rigidity.

11. The dolly of claim 5, where the mounting brackets comprise one of steel, or alloy angle or channel stock,
or metal brackets with mounting holes to connect with fasteners to secure to the platform of said dolly, or a plastic molding which is formed for the purpose of mounting the wheels;
and
wheel mounting holes to accept axles holding the wheels with a structure to allow the wheels to turn freely when assembled with the brackets.

12. The dolly of claim 5 where the wheels are of a rubber like material, such that the platform will travel freely in a straight line with a minimum of applied pressure in a direction of travel, and can follow large radius curves while traveling when light lateral pressure is applied to a front or a rear of a load on the upper surface, or when tension applied via a front of the platform at an acute angle to a line of travel.

13. A furniture dolly comprising:
a platform and first and second attached assemblies comprising mounting brackets and a plurality of wheels arranged as in-line rows,
and where one of:
all wheels are of equal dimensions and mounted so that they all contact a level surface when said dolly is upright,
or a leading and a trailing wheel of each assembly is larger than intermediate wheels for ease of traversing obstacles, and mounted so that all wheels contact a level surface when said dolly is upright,
or the leading and trailing wheel of each assembly is smaller than the intermediate wheels, and mounted so that the intermediate wheels contact a level surface when said dolly is upright and the leading and trailing wheels are elevated by a small amount above the same surface to aid intentional forward or backward tilting,
or all wheels are of equal dimensions, and mounted so that the intermediate wheels contact a level surface when said dolly is upright and the leading and trailing wheels are elevated by a small amount above the same surface to aid intentional forward or backward tilting.

14. The furniture dolly as in claim 13, wherein said wheels arranged as in-line rows are embodied as a plurality of rows in each mounting assembly so to distribute a load over a greater surface.

15. The furniture dolly as in claim 13, where rear wheels of said in-line wheel assemblies are inset from the rear of said platform, so that when downward pressure is applied to the rear of the platform either directly or through a load on the upper surface, or upward force is applied to a front of the load or to said dolly, said dolly will tip in a controlled manner and travel with only its rear wheels in contact with the surface to facilitate turning on a small radius curve.

16. The furniture dolly as in claim 13, wherein front wheels of said in-line wheel assemblies are inset from a front of said platform, so that when downward pressure is applied to the front of the platform either directly or through a load on the upper surface, or upward force is applied to a rear of the load said dolly will tip in a controlled manner and travel with only its front wheels in contact with the surface to facilitate turning on a small radius.

17. The furniture dolly as in claim 13, wherein rear wheels of said in-line rows are inset from the rear of said platform, and arranged such that when downward pressure is applied to the rear of the platform either directly or through a load on the upper surface, said dolly will tip in a controlled manner and travel with only its rear wheels in contact with the surface to facilitate mounting an obstacle in its path with its front wheels, and subsequently returning said dolly to the horizontal with upward pressure to the rear to traverse the obstacle and control the descent of a front of the dolly after the obstacle is crossed with downward pressure applied directly to the rear of the platform or via the load.

18. The furniture dolly as in claim 13, wherein
intermediate wheels of the in-line rows share a load when traveling on an even surface and carrying the load during the traversal of an elevated obstacle so that the assembly does not ground on the obstacle and that the following wheels are lifted so not to be stopped by a perpendicular face of the obstacle.

19. The furniture dolly as in claim 13, wherein a rope attached through an eye on one edge of the platform such that tilting may be alternatively or supplementally achieved by applying upward tension to the rope, for forward or backward tilting according to an orientation of said dolly at a time of application,
said rope used to draw said dolly forward when load is small and not readily handled by a standing operator.

20. The furniture dolly as in claim 13, wherein wheels of said in-line rows are inset from sides of said platform, to facilitate sideways tilting either by pressure applied directly to the side of the platform, lateral pressure applied to load or lifting from beneath the platform by hand or using a lever, to facilitate said dolly being recovered from being jammed by an obstacle on one side or bogged down in a soft surface.
